(19) United States
(12) Patent Application Publication
(10) Pub. No.: US 2011/0147037 A1
(43) Pub. Date: Jun. 23, 2011

(54) INTERCHANGEABLE DECORATIVE BEZEL FOR WIRING DEVICE

(75) Inventors: KANGPIN TEE, BROOKLYN, NY (US); JAMES RICHTER, BETHPAGE, NY (US)

(73) Assignee: LEVITON MANUFACTURING CO., INC., MELVILLE, NY (US)

(21) Appl. No.: 12/643,210

(22) Filed: Dec. 21, 2009

(51) Int. Cl. H02G 3/14; B23P 11/00

(52) U.S. Cl. 174/66; 29/428

(57) ABSTRACT

A wiring device capable of changing an aesthetic feature via a removable frame. The wiring device includes a front facing perimeter base having at least one opening. The wiring device also includes a removable bezel having a front face and a back face, the back face of the removable bezel surrounding at least a portion of the front facing perimeter base. The back face of the removable bezel includes a shielding wall for shielding ambient light from a sensor positioned on the front face perimeter base.

### BACKGROUND

1. Field of the Related Art

The present disclosure relates to wiring devices, and more particularly, to a frame or bezel interchangeably attached to a wiring device.

2. Background of the Related Art

There is an interest in customizing faceplates or receptacles to harmonize such devices with room decor such as wallpaper, drapes, furnishings and the like. Some people may prefer to personalize the faceplate or receptacle by displaying a favorite photographic or fanciful design. For example, in a child's room, it may be desirable to display a cartoon character or the likeness of an entertainer or sports figure on the faceplate or receptacle. Moreover, it may be desirable to display the logo of a favorite sports team or musical group. In business applications, it may be desirable to display a company logo or building safety/security information.

It will be appreciated that conventional faceplates or receptacles cannot accommodate such a wide variety of unique display requirements, most of which are personal. It will also be appreciated that such personal preferences may change from time-to-time, and that conventional faceplate or receptacle assemblies which utilize screw fasteners make such replacement difficult even when an appropriate decorator faceplate or receptacle may be found.

### SUMMARY

Objects and advantages of the present disclosure will be set forth in the following description, or may be obvious from the description, or may be learned through practice of the present disclosure.

Additional objects and advantages of the present disclosure are set forth in, or will be apparent to those skilled in the art from, the detailed description herein. Also, it should be further appreciated that modifications and variations to the specifically illustrated, referenced, and discussed steps, or features hereof may be practiced in various uses and embodiments of the present disclosure without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of the present disclosure may include various combinations or configurations of presently disclosed features or elements, or their equivalents (including combinations of features or parts or configurations thereof not expressly shown in the figures or stated in the detailed description).

The exemplary embodiments of the present disclosure relate to a wiring device having a front facing perimeter base having at least one opening. The wiring device further includes a removable bezel having a front face and a back face, the back face of the removable bezel surrounding at least a portion of the front facing perimeter base. The back face of the removable bezel includes a shielding wall for shielding ambient light from a sensor positioned on the front face perimeter base.

The exemplary embodiments of the present disclosure further relate to a method for customizing an appearance of a wiring device including removing a first bezel from the wiring device, the first bezel having a first aesthetic characteristic and attaching a second bezel to the wiring device, the second bezel having a second aesthetic characteristic. A back face of each of the first and second bezels includes a shielding wall for shielding ambient light from a sensor positioned on a front face perimeter base of the wiring device.

The exemplary embodiments of the present disclosure further relate to a method for providing multiple aesthetic characteristic options with a single wiring device including selling the wiring device with a removable frame and providing alternative frames that differ in appearance. A back face of the removable frame includes a shielding wall for shielding ambient light from a sensor positioned on a front face perimeter base.

The exemplary embodiments of the present disclosure further relate to a kit including a wiring device having a top facing perimeter base for receiving a removable frame and a plurality of removable frames each differing in an aesthetic from the other.

### BRIEF DESCRIPTION OF THE DRAWINGS

The foregoing and other objects, features, and advantages of the present disclosure will be apparent from the following more particular description of preferred embodiments as illustrated in the accompanying drawings, in which reference characters refer to the same parts throughout the various views. The drawings are not necessarily to scale, emphasis instead being placed upon illustrating principles of the present disclosure.

FIG. 1 is a schematic diagram of a perspective side view of a frame attached to a wiring device, in accordance with the present disclosure;

FIG. 2 is a schematic diagram of a perspective front view of the wiring device, in accordance with the present disclosure;

FIG. 3 is a schematic diagram of a perspective view of the frame disengaged from the wiring device, in accordance with the present disclosure;

FIG. 4 is a schematic diagram of a perspective back view of the frame disengaged from the wiring device, in accordance with the present disclosure;

FIG. 5 is a schematic diagram of a perspective front view of the frame disengaged from the wiring device at a first angle, in accordance with the present disclosure; and

FIG. 6 is a schematic diagram of a perspective front view of the frame disengaged from the wiring device at a second angle, in accordance with the present disclosure.

While the above-identified drawing figures set forth alternative embodiments, other embodiments of the present disclosure are also contemplated, as noted in the discussion. In all cases, this disclosure presents illustrated embodiments by way of representation and not limitation. Numerous other modifications and embodiments may be devised by those skilled in the art which fall within the scope and spirit of the principles of the present disclosure.

### DETAILED DESCRIPTION

The present disclosure proposes providing a faceplate assembly having a removable decorator insert frame or bezel which is retained without screw fasteners, and which may be easily removed and replaced with the use of a tool. The present disclosure further proposes providing an improved decorator frame or bezel assembly for an electrical wiring device, which covers the electrical wiring device and provides a clean, unbroken decorative appearance.

The present disclosure further proposes providing an improved wiring device assembly, in which a decorator insert frame or bezel may be installed and replaced without requiring removal of the wiring device or exposure of internal circuitry of the wiring device. Additionally, when the frame or bezel is removed, the wiring device remains fully functional without the exposure of any wiring or electrical components. The electrical components positioned within the wiring device are sealed off from the front surface of the wiring device, as well as from the frame or bezel at all times.

The present disclosure further proposes providing a shielding wall that prevents ambient light from inadvertently triggering a sensor placed on the front surface of the wiring device. The present disclosure further proposes that the bezel be a unitary, single-molded unit having no movable parts and no electrical parts.

Embodiments will be described below while referencing the accompanying figures. The accompanying figures are merely examples and are not intended to limit the scope of the present disclosure. In the description which follows, like parts are marked throughout the specification and drawings with the same reference numerals, respectively.

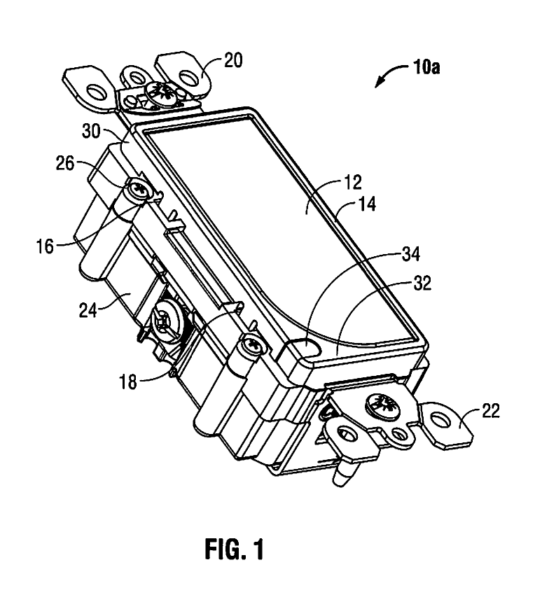

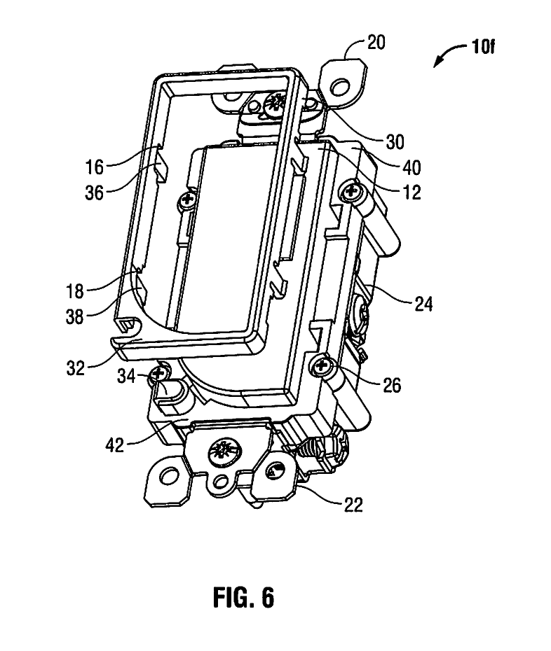

With reference to FIGS. 1-6, a frame attached to a wiring device is presented in a plurality of different views. These plurality of views are described below.

In FIGS. 1-6, the wiring device assembly 10A-F includes a guide light 12, a frame/bezel 14, a first recess 16, a second recess 18, a first mounting strap 20, a second mounting strap 22, a wiring device 24, and screws 26. The frame 14 includes a top portion 30 and a bottom portion 32. A sensor 34 is also provided adjacent the guide light 12 on the top surface of the wiring device 24.

The wiring device 24 may be installed in a conventional wall box. The wall box may be nailed against studs in a wall. The wall box may provide for a stable, protective enclosure in which the wiring device 24 may be safely mounted. Wiring leads (not shown) may be provided by the wiring device 24 for interconnection with electrical power distribution mechanisms for receiving power. The wiring device 24 may include a power supply, a processor, and a gate controlled power switch, all encapsulated within an insulation body (not shown). It is contemplated that the wiring device 24 may include a number of different electronic circuitry.

Moreover, wiring device 24 may be provided with two mounting straps, that is, a first mounting strap 20 and a second mounting strap 22 that are fastened on opposing ends of the wiring device 24 by suitable screw fasteners. Additionally, certain duplex outlets may include a threaded opening through a center portion for receiving a fastening screw for attaching the faceplate. Of course, one skilled in the art may contemplate a plurality of different wiring devices having a plurality of different frames or bezels for attachment to the wiring devices.

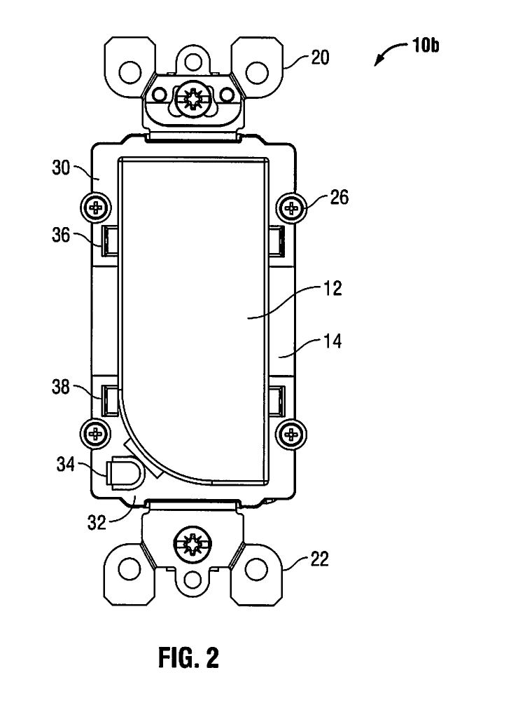

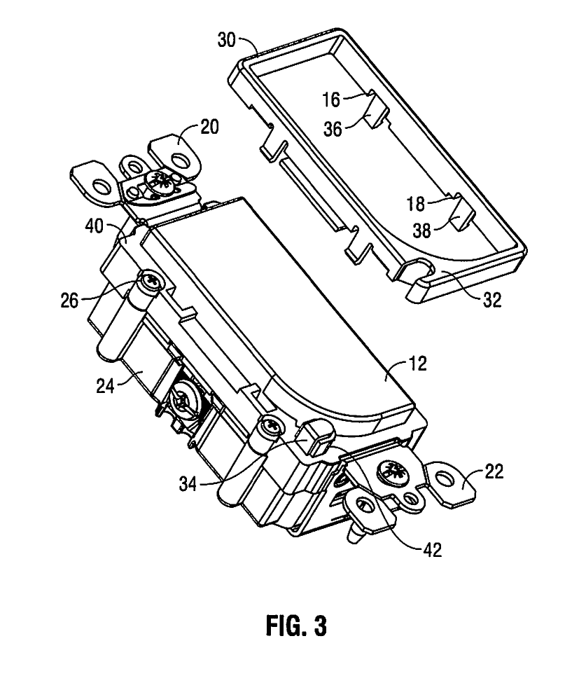

Referring back to FIGS. 1-6, the frame 14 may be attached and/or detached from the perimeter of the guide light 12 as a user sees fit. The frame 14 is designed to be removably coupled to or in association with or in cooperation with the guide light 12 of the wiring device 24. The frame 14 may include a plurality of tabs 36, 38 (see FIGS. 2 and 3). In this exemplary embodiment the frame 14 includes four tabs, as best shown in FIG. 3. The first tab 36 and the second tab 38 operate to connect or attach the frame 14 on one side of the guide light 12. The frame 14 includes tabs opposing tabs 26, 8 to connect the other side of the frame 14 to the guide light 12. Furthermore, each tab 36, 38 includes a recess 16, 18 on each side. The recesses 16, 18 are configured to receive a tool to remove the frame 14 from the wiring device 24. One skilled in the art may contemplate using a plurality of different tabs to connect or attach the frame 14 to the guide light 12, each of the tabs having an adjoining recess on either side. The plurality of tabs 36, 38 may be located or positioned on any edge of the frame 14 and may be spaced apart in equal or unequal predetermined distances. Thus, the plurality of tabs 36, 38 enable the frame 14 to be in cooperation or fixedly secured to the guide light 12 of the wiring device 24.

The frame 14 may be constructed or manufactured in a plurality of different colors, shapes, designs, patterns, and/or textures. The frame 14 may be considered a bezel. The frame 14 may be constructed in a rectangular shape. One skilled in the art may contemplate using a frame 14 in a variety of different shapes and sizes. The frame 14 may attach to the guide light 12 of the wiring device 24 by a snapping mechanism (i.e., snap-fit type mechanism). One skilled in the art may contemplate a plurality of different mechanism for attaching the frame 14 to the wiring device 24.

The frame 14 is positioned over or aligned with the guide light 12 to ensure proper alignment with the wiring device 24 when installation is completed with a press-fit engagement connection. The frame 14 may be installed and replaced without requiring removal of the wiring device 24, and without exposing the internal circuitry of the wiring device 24. In other words, before and after the installation of the frame 14 to the wiring device 24, no wirings are exposed.

The frame 14 may be constructed of any flexible or non-flexible material and imprinted with any fanciful logo, design, figure, pattern or aesthetic characteristic. The material may be a plastic material or a metal. Of course, one skilled in the art may contemplate using a plurality of different materials to construct the frame 14.

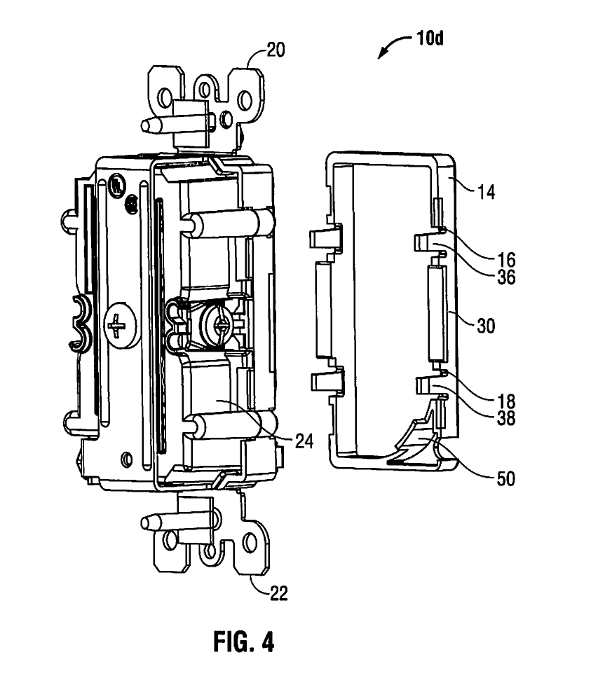

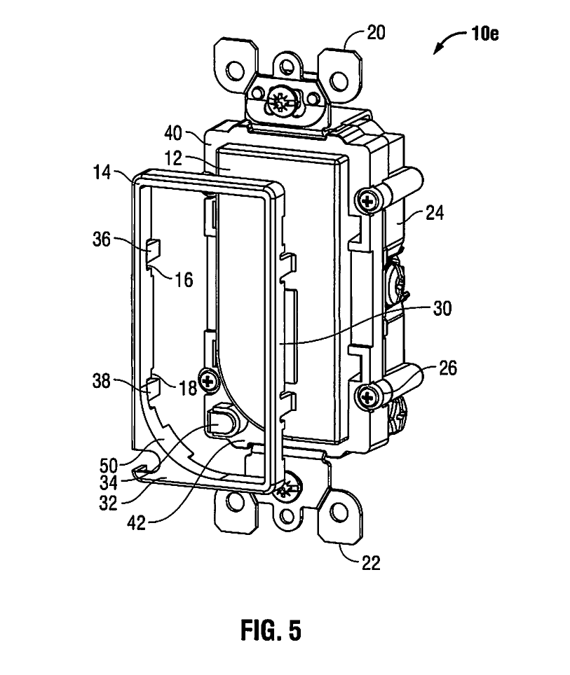

Referring back to FIGS. 1-6, the frame 14 may include a front face and a back face, the back face of the frame 14 surrounding at least a portion of the front facing perimeter base (e.g., guide light 12) of the wiring device 24. The back face of the frame 14 may include a shielding wall 50 (see FIGS. 4 and 5) for shielding ambient light from a sensor 34 positioned on the front face perimeter base of the wiring device 24.

The sensor 34 may be positioned on any portion of the front surface of the wiring device 24. The front surface of the wiring device 24 may be a light guide. In addition, the light sensor 34 may be used to capture stray light within the window area of frame 14. The sensor 34 minimally interferes with the light output from the light array located within the wiring device 24. The electrical signal from this sensor 34 may be used to indicate the relative intensity of the light emitted by the light array. This signal may be used to regulate the power to the light array to maintain a desired light output. The light array may be a light emitting diode (LED) array. However, the light array may be any type of lighting means contemplated by one skilled in the art.

Additionally, the sensor 34 may be separated from the guide light 12 by a shielding wall 50 (see FIGS. 4 and 5) in order to prevent ambient light from inadvertently triggering the sensor 34. The shielding wall 50 may be located on the back face of the frame 14 and may be molded to encompass a portion of the sensor 34.

Moreover, the wiring device 24 remains functional when the frame 14 is removed to be replaced with another bezel or frame. Also, the electrical components remain shielded when the frame 14 is removed to be replaced with another bezel or frame. The frame 14 may also be constructed as a unitary, single-molded unit that remains free from movable and electronic components. As a result, since no electrical components are exposed during removal and attachment of frames 14, the wiring device 24 remains a safe device. In a preferred configuration, a tool is used to remove the frame 14 from the wiring device 24. The tool may be configured to separate the frame 14 from the wiring device via the recesses 16, 18.

Additionally, a frame change kit may be provided. The kit may include a plurality of frames 14 or bezels, where each bezel may be of a different color, shape, design, pattern and/or texture. Each frame in the kit may include a different aesthetic characteristic. The kit may also include one or more wiring devices. A user may purchase a frame change kit in order to change the frame 14 as desired. The user may have the option to match the color of the wiring device 24 or the wall with the color of the frame 14. Of course, one skilled in the art may contemplate a plurality of different matching configurations. Moreover, a lens of the sensor 34 may be constructed from a different type of material with respect to the lens of the guide light 12. The kit may accommodate a plurality of different lenses for the sensor and the guide light.

With reference to FIGS. 3, 5, and 6 in the wiring device 24, the outer perimeter of the guide light 12 includes a top perimeter portion 40 and a bottom perimeter portion 42. The top portion 30 of the frame 14 may be positioned over the top perimeter portion 40 of the guide light 12 and the bottom portion 32 of the frame 14 may be positioned over the bottom perimeter portion 42 of the guide light 12 in order to properly align the frame 14 around the perimeter of the guide light 12. The frame 14 may be fixedly secured to the wiring device 24 via the plurality of tabs 36, 38, as described above. The recesses 16, 18 are configured to be exposed in order to receive a tool to aid the removal of the frame 14.

Alternately, the wiring device 24 may not include a guide light 12. In other words, the wiring device 24 may instead include one or more electrical outlets, such as a light, a receptacle, a switch, a dimmer, load controls (e.g., HVAC (heating, venting, and air conditioning)), shades, scene or zone controller, remote control, audio volume, etc. One skilled in the art may contemplate attaching a frame 14 or bezel to a plurality of different wall mounting systems. The exemplary embodiments of the present disclosure are not limited to guide light fixtures. For example, the guide light may be replaced by a switch or any other suitable electronic or electromechanical device contemplated by one skilled in the art.

In summary, the present disclosure describes a system and method that provides for a faceplate design with an open framework for accommodating removable inserts (e.g., frames or bezels), where the frames or bezels are fastened directly over the wiring device. The present disclosure further describes a means for easily accommodating several color options into one wiring device. For example, a single wiring device may include a plurality of bezels, each bezel molded in a different color or shape or design or pattern or texture or aesthetic characteristic. The user may be permitted to choose different, for instance, color bezels, and snap the desired colored bezels on the wiring device without interfering with the functionality of the wiring device. Furthermore, custom color bezel kits may be provided to users for purchase. An added benefit of the present disclosure may be to enable a user to remove the frame or bezel during painting of a room, or when it gets dirty or damaged or when the next holiday approaches.

Although exemplary systems and methods have been described in language specific to structural features and/or methodological acts, it is to be understood that the subject matter defined in the present disclosure is not necessarily limited to the specific features or acts described. Rather, the specific features and acts are disclosed as exemplary forms of implementing the methods, devices, systems, etc. of the present disclosure. The abstract and the title are not to be construed as limiting the scope of the present disclosure, as their purpose is to enable the appropriate authorities, as well as the general public, to quickly determine the general nature of the present disclosure.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art.

1. A wiring device comprising:
a front facing perimeter base; and
a removable bezel having a front face and a back face, the back face of the removable bezel surrounding at least a portion of the front facing perimeter base;
wherein the back face of the removable bezel includes a shielding wall for shielding ambient light from a sensor positioned on the front face perimeter base.

2. The wiring device according to claim 1, wherein the removable bezel includes a plurality of tabs.

3. The wiring device according to claim 2, wherein the plurality of tabs securedly fix the removable bezel to the wiring device.

4. The wiring device according to claim 1, wherein the removable bezel has a substantially rectangular shape.

5. The wiring device according to claim 1, wherein the removable bezel includes one or more of the following: different colors, shapes, patterns, and textures.

6. The wiring device according to claim 1, wherein the removable bezel attaches to the front facing perimeter base via a snapping mechanism.

7. The wiring device according to claim 1, wherein the wiring device is a wall-mounted electrical switch.

8. The wiring device according to claim 1, wherein the removable bezel is removable by the use of a tool.

9. The wiring device according to claim 1, wherein the wiring device remains functional when the removable bezel is removed.

10. The wiring device according to claim 1, wherein electrical components remain shielded when the removable bezel is removed.

11. The wiring device according to claim 1, wherein the removable bezel is a unitary, single-molded unit.

12. The wiring device according to claim 11, wherein the unitary, single-molded unit remains free from movable and electronic components.

13. The wiring device according to claim 1, wherein the front facing perimeter base further comprises at least one opening and a user interface disposed at least partially within the at lest one opening.

14. The wiring device according to claim 13, wherein the user interface is one of a switch, a dimmer, a receptacle, a lighting control, a load control, an occupancy sensor, a scene or zone controller, a remote control, or an audio volume control.

15. A method for customizing an appearance of a wiring device, the method comprising:
removing a first bezel from the wiring device, the first bezel having a first aesthetic characteristic; and
attaching a second bezel to the wiring device, the second bezel having a second aesthetic characteristic;
wherein a back face of each of the first and second bezels includes a shielding wall for shielding ambient light from a sensor positioned on a front face perimeter base of the wiring device.

16. The method according to claim 15, wherein the first and second bezels each include a plurality of tabs.

17. The method according to claim 16, wherein the plurality of tabs securedly fix the first and second bezels to the wiring device.

18. The method according to claim 15, wherein the first and second bezels each have a substantially rectangular shape.

19. The method according to claim 15, wherein the first and second bezels include one or more of the following: different colors, shapes, patterns, and textures.

20. The method according to claim 15, wherein the first and second bezels attach to a front facing perimeter base via a snapping mechanism.

21. The method according to claim 15, wherein the wiring device is a wall-mounted electrical switch.

22. The method according to claim 15, wherein the first and second bezels are removable by the use of a tool.

23. The method according to claim 15, wherein the wiring device remains functional when the first bezel is removed and the second bezel is attached.

24. The method according to claim 15, wherein electrical components remain shielded when the first bezel is removed and the second bezel is attached.

25. The method according to claim 15, wherein the first and second bezels are each unitary, single-molded units.

26. The method according to claim 25, wherein each of the unitary, single-molded units remain free from movable and electronic components.

27. The method according to claim 15, wherein the front facing perimeter base further comprises at least one opening and a user interface disposed at least partially within the at lest one opening.

28. The method according to claim 27, wherein the user interface is one of a switch, a dimmer, a receptacle, a lighting control, a load control, an occupancy sensor, a scene or zone controller, a remote control, or an audio volume control.

29. A method for providing multiple aesthetic characteristic options with a single wiring device, the method comprising:
providing the wiring device with a removable frame; and
providing alternative frames that differ in appearance;
wherein a back face of the removable frame includes a shielding wall for shielding ambient light from a sensor positioned on a front face perimeter base.

30. The method according to claim 29, wherein the removable frame is removable by the use of a tool.

31. The method according to claim 29, wherein the wiring device remains functional when the removable frame is detached.

32. The method according to claim 29, wherein electrical components remain shielded when the removable frame is removed.

33. The method according to claim 29, wherein the removable frame is a unitary, single-molded unit.

34. The method according to claim 33, wherein the unitary, single-molded units remain free from movable and electronic components.

35. A kit comprising:
a wiring device having a top facing perimeter base for receiving a removable unitary frame; and
a plurality of removable unitary frames each differing in an aesthetic characteristic from the other;
wherein a back face of the unitary removable frame includes a shielding wall for shielding ambient light from a sensor positioned on the front face perimeter base.

36. The kit according to claim 35, wherein each of the plurality of removable unitary frames has a different aesthetic, the aesthetic being one or more of color, shape, pattern, and texture.

37. The kit according to claim 35, wherein the sensor includes a first lens and the front face perimeter base includes a second lens, where the first lens is constructed from a different material than the second lens.
